(19) United States
(12) Patent Application Publication
(10) Pub. No.: US 2026/0285597 A1
(43) Pub. Date: Sep. 24, 2026

(54) SYSTEM AND METHOD FOR PERFORMING ITEM PICK-TO-LIGHT AND PUT-TO-LIGHT OPERATIONS

(71) Applicant: EXOTEC PRODUCT FRANCE, Croix (FR)

(72) Inventor: Louis ESQUERRE-POURTERE, Croix (FR)

(21) Appl. No.: 19/575,000

(22) Filed: Mar. 23, 2026

(30) Foreign Application Priority Data
Mar. 24, 2025 (FR) 2502994

(51) Int. Cl. B65G 1/137; G08B 5/22

(52) U.S. Cl. CPC B65G 1/1375; G08B 5/22

(57) ABSTRACT

A system for performing item picking and placement operations, having at least: a bin including a plurality of compartments, each compartment being configured to contain at least one item; a light indicator system, integrated into the bin, the light indicator system including at least one light indicator, each light indicator being associated with one compartment of the bin; a power supply interface configured to supply power to the light indicator system when the bin is positioned on the power supply interface; a controller, coupled to the power supply interface, configured to control the activation of the light indicators corresponding to the compartments containing at least one item to be picked or intended to receive at least one item to be placed.

### CROSS-REFERENCE

The present application claims priority to French Patent Application No. 2502994, filed March 24, 2025, the entirety of which is incorporated by reference.

### TECHNICAL FIELD

The present disclosure relates to the field of logistics and order picking. The present disclosure relates more particularly to a system and a method for carrying out pick-to-light and put-to-light operations of items.

### BACKGROUND

In the logistics sector, order picking generally involves a process of picking and placing items. This process usually involves an operator picking items from inventory, such as from shelves, racks or storage bins, and depositing them in a specific container, such as a preparation bin, a shipping carton or a sorting area.

Conventionally, operators consult a screen that displays the picking and placement instructions. This implies a cognitive load for the operators, as they have to mentally project the displayed information onto their physical environment. This discrepancy between digital display and reality can lead to misinterpretation, slower task execution and increased operator fatigue. The problem is even more acute when items are stored in compartmentalized bins, where each compartment may contain similar but different items.

It has been proposed to assist operators with a pick-to-light or put-to-light system. This system relies on the use of lighting devices placed on the storage locations in order to visually guide the operator. During picking (pick-to-light), a light comes on at the location of the item to be retrieved, and the operator can pick the item from the illuminated location. Conversely, when placing an item (put-to-light), the system illuminates the location where the item is to be deposited.

In automated storage and retrieval systems (ASRS), items are moved by automated transport systems. Autonomous vehicles or conveyors deliver storage bins directly to the operator. The operator then picks items from various compartments in the bin. In this case, pick-to-light and put-to-light systems may include lights arranged on a structure surrounding the bin, precisely indicating to the operator where to pick or deposit items. However, this structure imposes a constrained space around the bins, which can lead to a pinching hazard for the operator during handling, especially when the bins are moved by the automated transport system.

Alternatively, a projector located above the bin may display visual indications directly on the bin. However, the clarity of the projection is highly dependent on the surrounding light, which may make the display difficult to read in poorly lit environments. Moreover, when a bin contains many compartments, it becomes difficult to be precise, as the light projection may lack the precision to clearly identify each picking or placement location, making the system less efficient. This system may also be disrupted if the operator is positioned between the projector and the bin, thus creating a shadow that obscures the information displayed and reduces the legibility of the light indications.

### SUMMARY

This disclosure improves the situation.

A system for performing item picking and placement operations is proposed, comprising at least: a bin comprising a plurality of compartments, each compartment being configured to contain at least one item; a light indicator system, integrated into the bin, the light indicator system comprising at least one light indicator, each light indicator being associated with one compartment of the bin; a power supply interface configured to supply power to the light indicator system when the bin is positioned on the power supply interface; a controller, coupled to the power supply interface, configured to control the activation of the light indicators corresponding to the compartments containing at least one item to be picked or intended to receive at least one item to be placed.

Such a system improves the efficacy and precision of picking and placement operations. The integration of light indicators in the bin helps to visually guide the operator to the right location so as to pick or deposit an item, doing away with misinterpretations or pinching hazards and providing clear, constant illumination of the location at which to place or pick an item.

Additionally, a single power supply interface can supply power to a plurality of bins, simplifying integration of the solution into existing systems and reducing costs. The bin remains a passive element of the system, with no live components, making it easy to integrate, adapt and maintain the system.

Optionally, the system may further comprise an autonomous vehicle comprising a chassis, and the power supply interface may be integrated into the chassis of the autonomous vehicle. The upper surface of the chassis may be configured to transmit power to the light indicator system of the bin when the bin is positioned on the upper surface. This improves the fluidity of the picking and placement operations, as the placement or picking operation can be performed directly from the autonomous vehicle that has transported the bin. There is no transfer operation from the bin to the power supply interface.

Optionally, the light indicators may be arranged on an upper part of the bin, and the light indicator system may comprise a connection portion configured to connect each light indicator to the power supply interface. This physical arrangement of the light indicators on the upper part of the bin provides optimum visibility for the operator, thus reducing the risk of errors during picking and placement operations. This further reduces the risk of errors during operation. Via the connection portion, the light indicators may be powered without being in direct contact with the power supply interface.

Optionally, each light indicator may comprise an optical fiber, and the power supply interface may comprise a plurality of light sources, each optical fiber being configured to optically couple to one light source of the plurality of light sources. In this way, the light indicators may be illuminated by transmitting light from the power supply interface through optical fibers. The bin may be devoid of electronic components or conductors, and there is no transmission of electrical current directly in the bin, thus minimizing the risk of failure due to wear or to the presence of dust in the warehouse.

Optionally, each light indicator may comprise a light emitter, and the power supply interface may comprise an omnidirectional connector suitable for transmitting electrical power to each light indicator in at least two discrete positions of the bin on the power supply interface. In this case, the light indicators are illuminated by transmitting electrical power from the power supply interface, via electrical cables. This solution is easy to set up and offers low installation costs. The omnidirectional connector improves electrical contact between the power supply interface and each light emitter, doing away with the need for precise positioning between the bin and the interface.The electrical power supply can be maintained continuously, regardless of the orientation or rotation of the bin on the power supply interface.

According to another aspect, the invention proposes a method for picking and placing items implemented by a system comprising a server and at least one control system, the method comprising: the server receiving an order to pick and/or place items; the server identifying at least one specific bin comprising or intended to contain the items of the order; placing the specific bin on a power supply interface so as to connect a power source with a light indicator system integrated into the bin; the server transmitting, to the control system, information relating to compartments of the specific bin from which an item is to be picked or in which an item is to be deposited; the control system activating at least one light indicator among a plurality of light indicators of the light indicator system, each light indicator being associated with one compartment of the specific bin from which an item is to be picked or in which an item is to be deposited, indicating to an operator the location of the items to be picked or placed.

This improves the efficacy and precision of the picking and placement operations. The operator can be guided visually to the right location for picking or depositing an item, minimizing processing time and the risk of errors. Additionally, the bins themselves do not require any live components, further simplifying the integration of the solution into existing systems and reducing costs.

Optionally, the control system and the power supply interface can be integrated into a chassis of an autonomous vehicle, and placing the specific bin on the power supply interface may comprise: the server transmitting, to the control system, instructions to retrieve the specific bin; the control system controlling the movement of the autonomous vehicle towards the specific bin; the control system controlling the loading of the specific bin onto the chassis of the autonomous vehicle so as to place this specific bin on the power supply interface; the control system controlling the movement of the autonomous vehicle towards the operator. This configuration optimizes the flow of item picking and placement operations by eliminating any additional steps of transferring or moving the bin.

Optionally, activating the light indicators may comprise optically coupling a light source of the power supply interface and an optical fiber integrated into the specific bin. In this way, the light indicators may illuminate by light transmission from the power supply interface via the optical fibers.

Optionally, activating the light indicators may comprise establishing an electrical connection between an electrical power source of the power supply interface and a light emitter integrated into the specific bin. In this case, the indicators are illuminated by electrical power transmission from the power supply interface, via electrical cables.

Optionally, the method may further comprise: the server identifying a specific orientation of the bin placed on the power supply interface. This step reduces the potential for errors when identifying picking or placement locations. By determining the orientation of the bin, the system can precisely adjust the activation of the light indicators in order to match the actual arrangement of the compartments.

### BRIEF DESCRIPTION OF THE DRAWINGS

Further features, details and advantages will become apparent from the detailed description below, and from an analysis of the appended drawings, wherein:

FIG. 1 schematically illustrates an automated storage and retrieval system (ASRS), according to one embodiment.

FIG. 2 schematically illustrates an autonomous vehicle that can be implemented in the ASRS of FIG. 1.

FIG. 3 schematically illustrates a top view of a bin containing items that can be implemented in the ASRS of FIG. 1, according to one embodiment.

FIG. 4 schematically illustrates a side view of a system for performing item picking and placement operations that can be implemented in the ASRS of FIG. 1, according to one embodiment.

FIG. 5A and FIG. 5B schematically illustrate a side view of two further systems for performing item picking and placement operations that can be implemented in the ASRS of FIG. 1, according to one embodiment.

FIG. 6 illustrates a flowchart of an item picking and placement method according to one embodiment.

FIG. 7 illustrates a flowchart of a bin recovery method, according to one embodiment.

### DETAILED DESCRIPTION

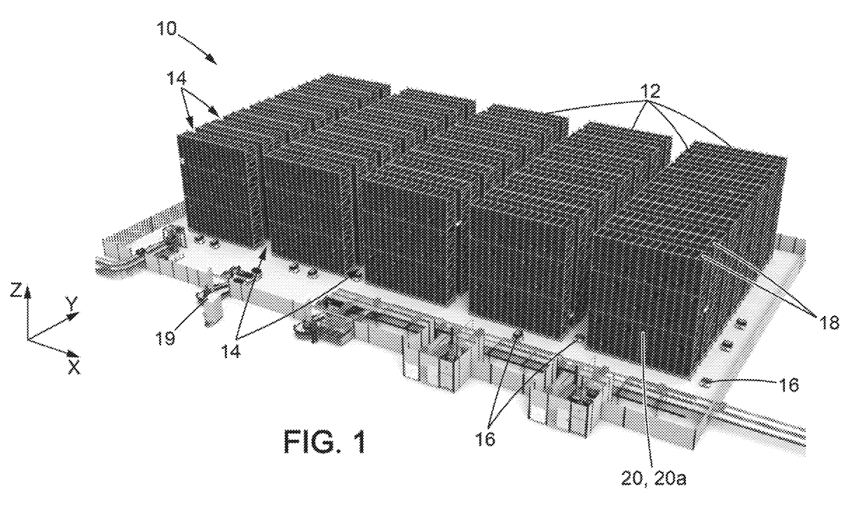

An automated storage and retrieval system (ASRS) 10 is illustrated in FIG. 1. Such a system is used in warehouses to store items.

The ASRS 10 comprises a plurality of storage racks 12 intended to receive items for storage, the items themselves being stored in storage bins. The storage racks 12 are spaced apart along a longitudinal direction x and a lateral direction y to form a grid of aisles 14 between which autonomous vehicles 16 can travel. Each storage rack 12 comprises a plurality of storage columns 18 arranged in rows. Each storage rack 12 may comprise one or two rows of storage columns 18. The storage columns 18 receive bins 20 (or other carriers/containers/pallets), the bins 20 being stacked one on top of the other along the storage column 18 (that is, in a vertical direction z). The bins 20 receive the items, and the stacking of the bins enables high-density storage of the items in the warehouse.

The ASRS 10 may also comprise an order-picking station 19 at which an operator may be positioned so as to pick the items of an order. The bins 20 containing one or more items of the order may be conveyed from their storage location in a storage rack 12 to the operator.

To this end, the ASRS 10 may comprise a plurality of autonomous vehicles 16 or AGVs (Auto Guided Vehicles). The plurality of autonomous vehicles 16 move around the aisles 14 in the longitudinal and lateral directions x,y and in the vertical direction z in order to access all the bins 20 stored in the ASRS 10. The autonomous vehicles 16 may perform bin 20 placement and removal tasks by moving in the longitudinal, lateral and vertical directions x,y,z. The autonomous vehicles 16 may also transport the bins to and from the order-picking station 19.

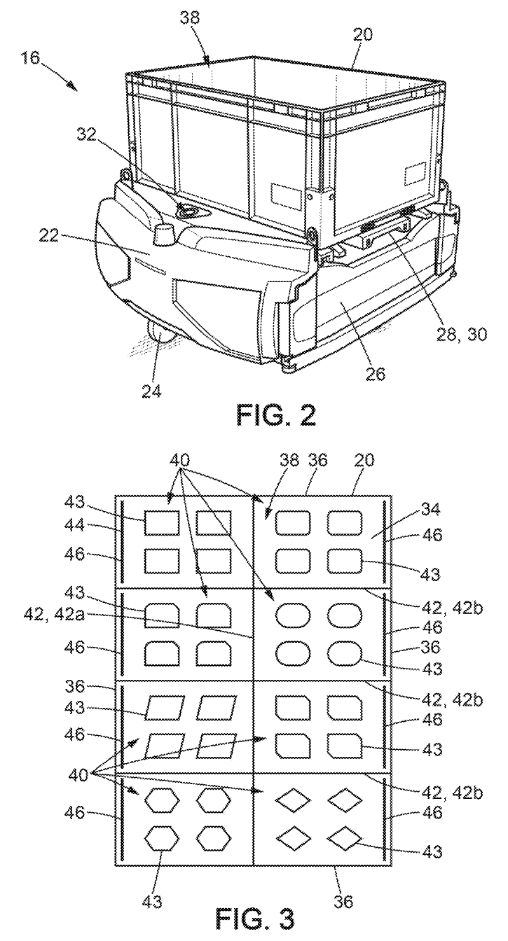

FIG. 2 illustrates an autonomous vehicle 16 in greater detail.

The autonomous vehicle 16 comprises a chassis 22, typically with a parallelepipedal shape, and motorized movement means 24 mounted on the chassis 22. The movement means 24 enable the autonomous vehicle 16 to move across the ground (especially in the lateral and longitudinal directions x,y). The movement means 24 enable the autonomous vehicle 16 to move freely across the ground, in particular in the aisles 18 or to/from the order-picking station 19.

The autonomous vehicle 16 also comprises an ascent and descent system 26 suitable for moving in a vertical direction z. In addition to the two planar dimensions generally associated with the ground on which the autonomous vehicle 16 moves, there is a third vertical dimension z associated with the storage racks 12 on which the autonomous vehicle 16 is able to move vertically. The vertical movement system 26 may engage with the storage columns 18 of two adjacent storage racks 12 and move along the storage columns 18.

The autonomous vehicle 16 further comprises loading means 28. The loading means 28 may comprise a deployable fork 30 that can be deployed from the chassis 22 so as to be deployed into a storage compartment of the storage rack 12 in order to place or retrieve a bin 20 contained within the storage compartment. The deployable fork 30 is suitable for extracting the bin 20 from the storage compartment and loading it onto an upper surface 32 of the chassis 22. The deployable fork 30 is also suitable for depositing the bin 20 in a storage compartment from the upper surface 32 of the chassis 22.

FIG. 3 illustrates in greater detail an example of a bin 20 intended to hold items stored in the ASRS 10. The bin 20 may be stored in a storage rack 12, in particular in a storage compartment of the storage rack 12, and may be carried on the chassis 22 of the autonomous vehicle 16, in particular on the upper surface 32 of the chassis 22.

The bin 20 is rectangular in shape and comprises a bottom 34 and outer walls 36, extending from the bottom 34 in order to define an open receiving space 38 of the bin 20. The open receiving space 38 is divided into a plurality of compartments 40. The compartments 40 are delimited from each other by internal partitions 42 extending between the opposite outer walls 36 of the bin 20, in the longitudinal and/or lateral direction. Each compartment 40 may store one or more discrete items 43.

In the illustrated example, the bin 20 comprises eight compartments 40. In this case, the compartments 40 are delimited by a longitudinal inner partition 42a and three lateral inner partitions 42b. Alternatively, the bin 20 may comprise between two and ten compartments 40.

Additionally, the bin 20 comprises a light indicator system 44. The light indicator system 44 comprises a plurality of light indicators 46. Each compartment 40 of the bin 20 is associated with at least one light indicator 46 in order to identify or signal a specific compartment 40. In one example in which the number of light indicators 46 matches the number of compartments 40, each compartment 40 has a dedicated light indicator 46. Alternatively, when the bin 20 includes more light indicators 46 than compartments 40, several light indicators 46 may be associated with a single compartment 40. The organization of the compartments 40 is modular without requiring any modification of the light indicators 46. Each light indicator 46 may light up with a single color, or with a plurality of different colors.

The light indicators 46 are powered by a power supply interface 48, which is separate from the bin 20. The indicator lights 46 are supplied with power when the bin 20 is positioned on the power supply interface 48. The power supply interface 48 makes it possible to transmit the power suitable for lighting each light indicator 46 when the bin 20 is on the power supply interface 48. The bin 20 may remain a passive element, with no integrated power source. This architecture reduces the implementation costs by enabling the use of a large number of bins 20 with a single power supply interface 48, thus optimizing the overall infrastructure. Moreover, by avoiding the need to integrate complex electronic components into each bin 20, the power supply interface 48 facilitates maintenance and improves the durability of the system, while guaranteeing efficient and flexible management of the lighting of the light indicators 46.

In one exemplary embodiment, the power supply interface 48 is integrated into the chassis 22 of the autonomous vehicle 16. The chassis has an on-board power source, and the upper surface 32 of the chassis 22 can transfer power to the bin 20 when the bin 20 is placed on this upper surface 32. The power is transmitted by contact between the upper surface 32 of the chassis 22 and the bottom 34 of the bin 20. Alternatively, the power supply interface 48 may be independent of the autonomous vehicle 16, for example located at the order-picking station 19. In this case, the autonomous vehicle 16 may deposit the bin 20 on a flat surface connected to a power source.

The upper surface 32 of the chassis 22, or where applicable the flat surface, may further comprise one or more fingers 54 projecting from the upper surface 32 (or from the flat surface). For example, four fingers 54 may protrude from four corners of the upper surface 32 (or of the flat surface). Each finger 54 may be inserted at least partially, if not totally, into a relief variation of the bin 20 in order to engage the bin 20 with the power supply interface 48. The fingers 54 ensure correct alignment of the bin 20 on the power supply interface 48, so that the power supplied by the power supply interface 48 is transmitted to the light indicators 46. Each finger 54 may also be arranged on the deployable fork 30 in order to enable the autonomous vehicle 16 to push and pull the bins to and from the storage compartments. Each finger 54 may also be used to hold the bin 20 in position on the upper surface 32 of the chassis 22 of the autonomous vehicle 16 during movements.

Alternatively, when the fingers 54 do not protrude from the upper surface 32 of the chassis 22, they are retractable fingers, with a recessed position in which they are recessed in this upper surface 32, and a deployed position in which these fingers protrude at least partially from this upper surface 32. Similarly, in the deployed position, each finger may be inserted at least partially, if not totally, into a relief variation of the bin 20 in order to engage the bin 20 with the power supply interface 48. The fingers 54 ensure correct alignment of the bin 20 with the power supply interface 48.

As illustrated, each light indicator 46 is positioned on an upper part of the bin 20, that is, a part at a distance from the bottom 34 of the bin 20. For example, the light indicators 46 may be arranged at regular intervals on the outer walls 36 of the bin 20, in the vicinity of the upper edge of the outer walls 36. A connection portion 56 may connect each light indicator 46 to the power supply interface 48.

The light indicator system 44 may be integrated into the bin 20 during the manufacture of the bin 20, especially by injection molding, so that the light indicator system 44 is permanently and solidly integrated into the bin 20. Alternatively, the light indicator system 44 may be attached to the bin 20 after manufacturing, so that the light indicators 46 can be added to bins 20 that have already been manufactured.

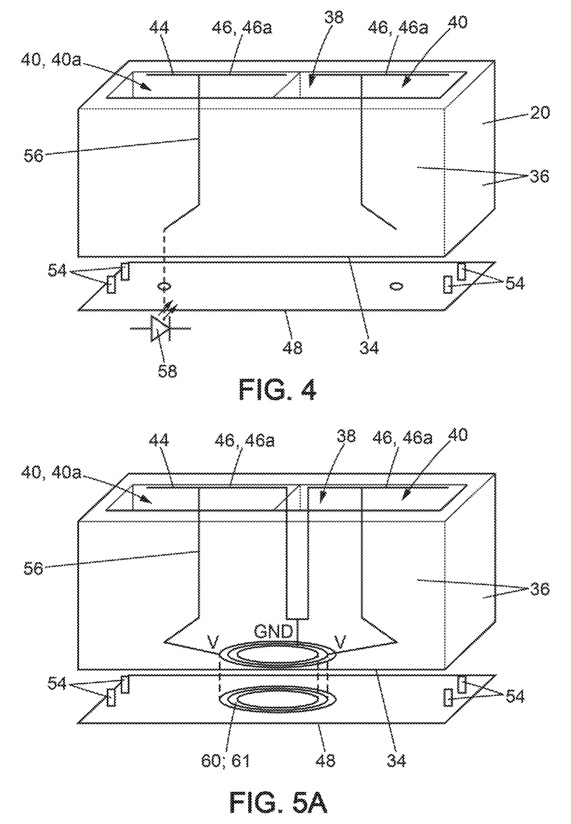

In an embodiment illustrated in FIG. 4, each light indicator 46 comprises an optical fiber 46a, and the power supply interface 48 comprises a plurality of light sources 58, such as LEDs. When the bin 20 is positioned on the power supply interface 48, each light source 58 is associated with an optical fiber 46a. The light emitted by each light source 58 passes through the associated optical fiber 46a, from an input located near the light source 58 to an output positioned to illuminate a specific compartment 40 of the bin 20. In some cases, an optical lens may be provided on each light source 58, to make the light converge towards the input of the associated optical fiber 46. The connection portion 56 may, in this example, correspond to a portion of optical fiber 46a.

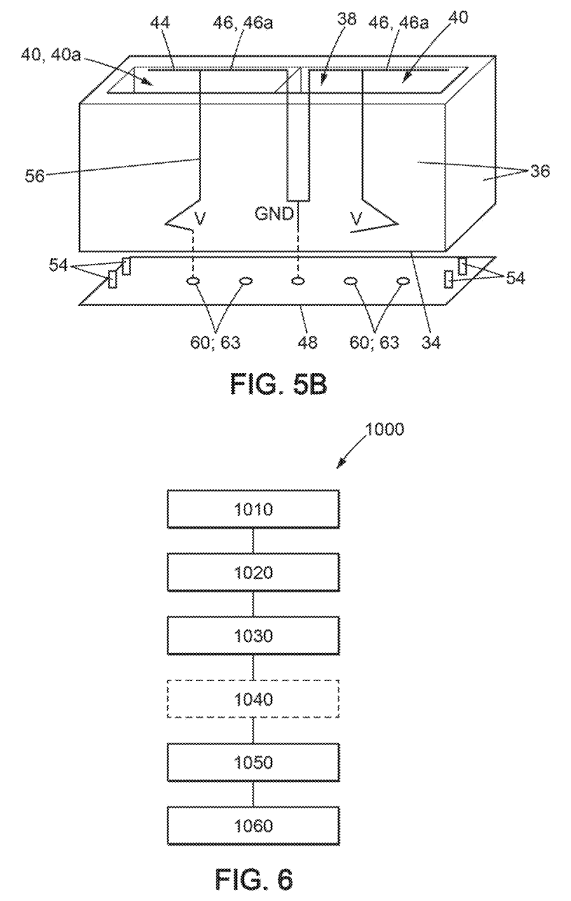

In another exemplary embodiment, illustrated in FIGS. 5A and 5B, the power supply interface 48 comprises an omnidirectional connector 60 for transmitting electrical power to the bin 20. As used herein, omnidirectional connector 60 means a connector for establishing an electrical connection with the bin 20 in at least two orientations of the bin 20 on the power supply interface 48. Each light indicator 46 comprises a light emitter 46b, such as an LED strip, and is connected to the omnidirectional connector 60 by the connection portion 56 in the form of a cable 56. Each cable 56 extends between an input V (positive) and an output GND (negative) configured to be in contact with corresponding surfaces of the omnidirectional connector 60. When the bin 20 is positioned on the power supply interface 48, the electrical power is transmitted via cables 56 to each light emitter 46b to illuminate the compartments 40 that contain the items to be retrieved or deposited.

In FIG. 5A, the omnidirectional connector 60 is in the form of a rotating connector 61. In this case, each cable 56 may come into contact with a corresponding ring-shaped surface, thus ensuring the continuous transmission of electrical power to each light emitter 46b, regardless of the orientation or rotation of the bin 20 on the power supply interface 48.

In FIG. 5B, the omnidirectional connector 60 is in the form of spring-loaded connectors 63 arranged symmetrically with respect to a central axis of the power supply interface 48. In this case, each cable 56 is arranged to come into contact with an associated spring-loaded connector 63 when the bin 20 is positioned on the power supply interface 48 in either direction. In this configuration, the bin 20 may be arranged in one of two diametrically opposed positions with respect to the central axis, while ensuring continuity of the electrical power supply.

The power supply interface 48 is driven by a controller, which is coupled and configured to manage the lighting of the light indicators 46, depending on the compartments 40 containing items to be retrieved or deposited. The controller may switch on, switch off or change the color of the light indicators 46, according to operational requirements. The controller may be used to selectively control the lighting of light indicators 46 according to operational requirements, especially to signal the compartments storing an item to be retrieved or into which an item is to be placed. The controller may be programmed to receive instructions from an external control system, such as the system that is integrated into an autonomous vehicle 16 or a centralized management system for the power supply interface 48.

A method 1000 for picking and placing items is described hereinafter, referring to FIG. 6. The method 1000 may be implemented by a system comprising a control system and a server.

The server may, for example, be a central computer system that manages all the operations for storing and retrieving items in the ASRS. For example, the server may be responsible for coordinating autonomous vehicles 16, for receiving and organizing orders, and for ensuring that the items are efficiently stored, located and retrieved in the ASRS 10.

The control system may be the system controlling the operation of the autonomous vehicle 16, for example the movements of the autonomous vehicle 16 and the removal/placement of bins within the ASRS 10. The control system may be integrated into the autonomous vehicle 16. The control system may also be integrated into a station of the ASRS 10, for example into the order-picking station 19.

The method 1000 comprises a first step 1010 in which the server receives an order. The order may comprise one or more items to be retrieved from one or more bins stored in the warehouse, in which case the method is a pick-to-light method. The order may also comprise one or more items to be deposited in one or more bins stored in the warehouse, in which case the method is a put-to-light method.

The method 1000 comprises a second step 1020 in which the server identifies at least one specific bin 20a containing one or more items of the order or intended to receive one or more items of the order. The server may especially identify the aisle 14 and the storage column 18 in which the specific bin 20a is stored, and may identify the position of the specific bin 20a in this storage column 18. In the example in which the order is a placement order for one or more items, the server can identify the aisle 14, the storage column 18 and the position in the storage column 18 that includes the specific bin 20a intended to receive the one or more items to be stored.

The method 1000 comprises a third step 1030 of placing the specific bin 20a on the power supply interface 48. The specific bin 20a deposited on the power supply interface 48 enables the power supply interface 48 to be connected to each of the light indicators 46 of the specific bin 20a. The power supply interface 48 is thus suitable for transmitting energy, for example light or electrical power, to each of the light indicators 46. The third step 1030 may, for example, be performed by conveying the specific bin 20a to the power supply interface 48 by a conveyor, by an operator or by an autonomous vehicle 16.

In some cases, the method 1000 may comprise an optional fourth step 1040 of the server determining the orientation of the specific bin 20a on the power supply interface 48. Determining the orientation of the specific bin 20a enables the server to confirm the position of each compartment 40 on the power supply interface 48.

The method 1000 comprises a fifth step 1050 of the server transmitting, to the control system, information relating to the specific compartments 40a of the specific bin 20a from which an item is to be picked or into which an item is to be deposited.

The method 1000 comprises a sixth step 1060 of the control system activating the light indicators 46 of the light indicator system 44 that are associated with the specific compartments 40a, thus indicating to an operator the location of the items to be picked or placed. In some cases, activation involves connecting light sources 58 with optical fibers 46a. Alternatively, activation involves connecting a rotating connector 60 with light emitters 46b. Activation of the light indicators 46 may be controlled by a controller communicating with the control system.

The method 1000 described hereinbefore may be implemented for each bin 20 including one or more items of the order, or into which one or more items are to be deposited.

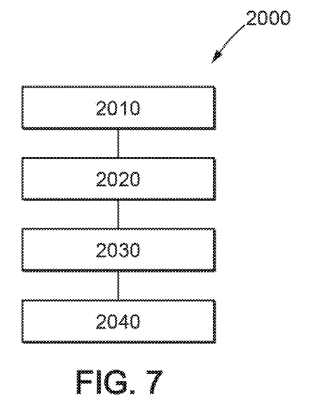

When the third step 1030 is performed by the autonomous vehicle 16, the control system and power supply interface are integrated into the chassis 22 of the autonomous vehicle 16, and the third placement step 1030 may comprise a sub-method 2000 for retrieving the specific bin 20a, illustrated in FIG. 7.

The sub-method 2000 especially comprises a first step 2010 of the server transmitting, to the control system, instructions to retrieve the specific bin 20a. The server may especially transmit the storage position of the specific bin 20a in the ASRS 10, so that the autonomous vehicle 16 can determine the movements to be made in order to retrieve the specific bin 20a.

The sub-method 2000 comprises a second step 2020 of the control system controlling the movement of the autonomous vehicle 16 towards the position of the specific bin 20a. The autonomous vehicle 16 may move vertically over the ground and along the storage racks 12 so as to access the position of the specific bin 20a. The control system may control the movement means 24 of the autonomous vehicle 16, and the vertical movement system 26 of the autonomous vehicle 16.

The sub-method 2000 further comprises a third step 2030 of the control system controlling the loading of the specific bin 20a onto the chassis 22 of the autonomous vehicle 20a. Herein, the control system may control the loading means 28 of the autonomous vehicle 16 in order to place the specific bin 20a on the upper surface 32 of the chassis 22.

The sub-method 2000 comprises a fourth step 2040 of the control system controlling the autonomous vehicle 16 to move towards an operator, for example an operator positioned at the order-picking station 19. Herein again, the control system may control the vertical movement system 26 and the movement means 24 of the autonomous vehicle 16. The autonomous vehicle 16 may be positioned in front of the operator, so that the operator can easily retrieve the items contained in the specific bin 20a.

In other examples, the specific bin 20a may be placed on the power supply interface 48 in another way, for example by being conveyed by a conveyor, or by being deposited by the autonomous vehicle 16 that retrieved the specific bin 20a.

What is claimed is:

1. A system for performing item picking and placement operations, the system comprising:
a bin comprising a plurality of compartments, each compartment being configured to hold at least one item;
a light indicator system, integrated into the bin, the light indicator system comprising at least one light indicator, each light indicator being associated with one compartment of the bin;
a power supply interface configured to supply power to the light indicator system when the bin is positioned on the power supply interface;
a controller, coupled to the power supply interface, configured to control the activation of the light indicators corresponding to the compartments containing at least one item to be picked or intended to receive at least one item to be placed; and
an autonomous vehicle comprising a chassis, the power supply interface being integrated into the chassis of the autonomous vehicle and an upper surface of this chassis being configured to transmit power to the light indicator system of the bin when this bin is positioned on the power supply interface, the autonomous vehicle further comprising loading means for placing the bin on the upper surface of the chassis.

2. The system according to claim 1, wherein the light indicators are arranged on an upper part of the bin, and wherein the light indicator system comprises a connection portion configured to connect each light indicator to the power supply interface.

3. The system according to claim 1, wherein each light indicator comprises an optical fiber, and the power supply interface comprises a plurality of light sources, each optical fiber being configured to optically couple to one light source of the plurality of light sources.

4. The system according to claim 1, wherein each light indicator comprises a light emitter, and the power supply interface comprises an omnidirectional connector suitable for transmitting electrical power to each light emitter in at least two discrete positions of the bin on the power supply interface.

5. A method for picking and placing items implemented by a system comprising a server and at least one control system, the method comprising:
the server receiving an order to pick and/or place items,
the server identifying at least one specific bin comprising or intended to contain the items in the order,
placing the specific bin on a power supply interface so as to connect a power source with a light indicator system integrated into the specific bin;
the server transmitting, to the control system, information relating to compartments of the specific bin from which an item is to be picked or into which an item is to be deposited;
the control system activating at least one light indicator among a plurality of light indicators of the light indicator system, each light indicator being associated with one compartment of the specific bin from which an item is to be picked or into which an item is to be deposited, indicating to an operator the location of the items to be picked or placed;
wherein the control system and the power supply interface are integrated into a chassis of an autonomous vehicle, and placing the specific bin on the power supply interface comprises:
the server transmitting, to the control system, instructions to retrieve the specific bin;
the control system controlling the movement of the autonomous vehicle towards the specific bin;
the control system controlling the loading of the specific bin onto the chassis of the autonomous vehicle, by loading means of the autonomous vehicle, so as to place this specific bin on the power supply interface;
the control system controlling the movement of the autonomous vehicle towards the operator.

6. The method according to claim 5, wherein activating at least one light indicator comprises optically coupling a light source of the power supply interface and an optical fiber integrated into the specific bin.

7. The method according to claim 5, wherein activating at least one light indicator comprises establishing an electrical connection between an electrical power source of the power supply interface and a light emitter integrated into the specific bin.

8. The method according to claim 5, which further comprises: the server identifying a specific orientation of the bin placed on the power supply interface.
